(19) United States
(12) Patent Application Publication
(10) Pub. No.: US 2015/0263519 A1
(43) Pub. Date: Sep. 17, 2015

(54) DEMAND AREA POWER SYSTEM BUILDING SYSTEM, VIRTUAL ELECTRICAL GRID BUILDING APPARATUS, POWER TRANSMISSION/RECEPTION UNIT, DEMAND AREA POWER SYSTEM BUILDING METHOD, AND PROGRAM

(71) Applicant: NEC Corporation, Tokyo (JP)

(72) Inventor: Hideaki SUZUKI, Tokyo (JP)

(73) Assignee: NEC Corporation, Tokyo (JP)

(21) Appl. No.: 14/659,434

(22) Filed: Mar. 16, 2015

(30) Foreign Application Priority Data
Mar. 17, 2014 (JP) 2014-053674

(51) Int. Cl. H02J 3/00; G05B 15/02

(52) U.S. Cl. CPC H02J 3/005; G05B 15/02

(57) ABSTRACT

A demand area power system building system includes at least one power transmission/reception unit that comprises a power storage unit and power transmitting and receiving units capable of transmitting and receiving power to/from another power transmission/reception unit via an electrical grid and that is configured to be able to provide power accumulated in the power storage unit to the outside or to be able to accumulate power supplied from the outside; and a virtual electrical grid building apparatus, connected to the power transmission/reception unit via a communication network, that controls the power transmission/reception unit so as to provide power to a demand area. The power transmission/reception unit is adapted to announce participation to a demand area power system via the communication network, and the virtual electrical grid building apparatus builds a demand area power system using the power transmission/reception unit that has announced participation to the demand area power system.

### TECHNICAL FIELD

The present invention is based upon and claims the benefit of the priority of Japanese patent application No. 2014-053674, filed on Mar. 17, 2014, the disclosure of which is incorporated herein in its entirety by reference thereto.

The present invention relates to a demand area power system building system, virtual electrical grid building apparatus, power transmission/reception unit, demand area power system building method, and program, and particularly to a demand area power system building system, virtual electrical grid building apparatus, power transmission/reception unit, demand area power system building method, and program that build a distribution system close to a demand area utilizing distributed generation.

### BACKGROUND

Patent Literatures 1 and 2 propose next-generation distribution systems such as “smart community” and “smart grid” that assume the use of various power sources (solar power generation, wind power generation, fuel cell power generation, etc.) in the distribution systems. Further, a new distribution system called “demand area power system” has also been proposed as a concept similar to “smart grid.”

In prior literatures on demand area power systems, there are a grid-interconnection type that connects to a power feeding system and a type that builds a stand-alone demand area power system. The type grid-connected to a power feeding system includes a system that monitors the voltage of the power feeding system and adjusts the power supply of a supplier so as to maintain a constant voltage, and a system in which consumers and suppliers work together. When the amount of distributed power increases, the main power feeding system becomes unstable and it becomes difficult to freely conduct electric power exchanges because power exchanges will be about purchasing and selling power with the main power feeding source. Therefore, stand-alone demand area power systems have attracted attention.

A stand-alone demand area power system often assumes that many consumers and suppliers are connected in a loop topology system. For instance, the coordination of the operation of consumers and suppliers on the basis of a power generation forecast of wind power, etc., and a power consumption forecast is considered. A loop topology is suitable for a fixed and strategically placed demand area power system, but it is not suitable in a case where an electrical grid is dynamically constructed. In addition, it has a weakness that a failure in one place can easily affect the entire system.

As a method capable of overcoming these weaknesses, a demand area power system using a hub-and-spoke or mesh topology has been proposed. A challenge in these configurations is the routing of power. It corresponds to the control of layer 2 and layer 3 in the IP (Internet Protocol) network field.

Regarding the routing of power, there is a technology called digital grid router (DGR). Non-Patent Literatures 3 to 5 describe digital grid and DGR in detail. Digital grid is another technology aiming at building a demand area power system, but its effects are different since the implementation method is different. A digital grid is implemented by providing power between small-scale demand area power systems capable of storing power. A demand area power system in a digital grid is called a cell and examples include a loop-type demand area power system and a building comprising a BEMS (Building Energy Management System). The cells are linked by a DGR and provide power to each other. The method for providing power is thought to be optimized by the financial dealing of power between the cells according to market principles. The cells can be nested, but a different technology is required to build the smallest unit.

In addition, Patent Literature 1 discloses a power system in which power exchanges between different power system power apparatuses and simultaneous and asynchronous power exchanges among a plurality of power systems become possible by integrating power control in a configuration in which a power system is divided into a plurality of autonomous power systems, as the digital grid described above.

Further, Patent Literature 2 discloses an energy management system having a group data storage unit that stores group data in which a plurality of consumers managing or owning power demand facilities that receive power from power supply facilities are integrated as a consumer group that includes at least one consumer owning or managing a distributed power supply; a power demand data storage unit that stores the power demand data of the power demand facilities owned by the consumer group; and an output command value calculation unit that calculates a power generation output command value for the distributed power supply of the consumer group on the basis of the power demand data.

Further, Patent Literature 3 discloses a configuration comprising system state monitoring means for monitoring the state of a distribution system; load exchange amount calculation means for calculating a power outage section in the distribution system and a load exchange amount for the power outage section on the basis of the state of the distribution system and of distribution system facility data about the facilities of the distribution system; distributed power state grasping means for grasping the state of distributed power supplies on the basis of the amount of electricity of the distributed power; and load exchange route selection means for selecting a load exchange route, in which the load exchange amount is exchanged within the distribution system, on the basis of the state of the distributed power, the load exchange amount, distributed power facility data about the facilities of the distributed power, and the distribution system facility data in a distribution system monitoring and control apparatus that receives power supply from a higher power system and that monitors or controls the distribution system interconnected to a plurality of the distributed power supplies.

[Patent Literature 1]

Japanese Patent Kokai Publication No. JP2011-61970A

[Patent Literature 2]

Japanese Patent Kokai Publication No. JP2005-198423A

[Patent Literature 3]

Japanese Patent Kokai Publication No. JP2006-304403A

[Non-Patent Literature 1]

New Energy and Industrial Technology Development Organization, “NEDO Renewable Energy Technology White Paper,” [online], [searched on Mar. 4, 2014], the Internet <URL: http://www.nedo.go.jp/library/ne_hakusyo_index.html>

[Non-Patent Literature 2]

New Energy and Industrial Technology Development Organization, “The Current Status of and Roadmap for the Smart Grid Technology,” [online], [searched on Mar. 4, 2014], the Internet <URL: http://www.nedo.go.jp/content/100107277.pdf>

[Non-Patent Literature 3]

The Digital Grid Consortium, “Summary—The Digital Grid Consortium,” [online], [searched on Mar. 4, 2014], the Internet <URL: http://www.digitalgrid.org/jp/about-digital-grid>

[Non-Patent Literature 4]

NEC Corporation, “New Power Supply System Supported by ICT and Power Storage Technology: [column] Smart Energy Forefront|NEC Power Control Network's Window “Digital Grid Router (DGR),” [online], [searched on Mar. 4, 2014], the Internet <URL: http://jpn.nec.com/energy/features/37/contents3.html>

[Non-Patent Literature 5]

Abe, Rikiya, “Can the Near Future Be Changed? Digital Grid: the Future of the Smart Grid,” [online], [searched on Mar. 4, 2014], the Internet <URL: http://www.sselab.t.u-tokyo.ac.jp/kifu/pdf/20110513abe.pdf>

### SUMMARY

The following analysis is given by the present invention. One of the applications expected from the demand area power system described above is to provide power in a disaster area or battle area. On the one hand, demand area power systems, which utilize distributed generation such as solar and wind power, have an advantage in terms of equipment cost and are often grid-interconnected (utilizing a power feeding system) with normal outlets available for use. On the other hand, as described above, a demand area power system grid-interconnected to a power feeding system is unlikely to function when the power feeding system is cut off by a disaster. Further, in a disaster area, a distributed generator installed therein may be damaged by the disaster and may not be available. A distributed generator is sometimes brought in to a disaster or battle area from the outside, and a method capable of grasping these distributed generators and quickly building a demand area power system is in need.

It is an object of the present invention to provide a demand area power system building system, virtual electrical grid building apparatus, power transmission/reception unit, demand area power system building method, and program contributing to expediting and enriching the construction of a demand area power system, especially a demand area power system that does not assume a grid-interconnection to a power feeding system.

According to a first aspect, there is provided a demand area power system building system including at least one power transmission/reception unit that comprises a power storage unit and power transmitting and receiving units capable of transmitting and receiving power to/from another power transmission/reception unit via an electrical grid and that is configured to be able to provide power accumulated in the power storage unit to the outside or to be able to accumulate power supplied from the outside, and a virtual electrical grid building apparatus, connected to the power transmission/reception unit via a communication network, that controls the power transmission/reception unit so as to provide power to a demand area; the power transmission/reception unit is adapted to announce participation to a demand area power system via the communication network; and the virtual electrical grid building apparatus builds a demand area power system using the power transmission/reception unit that has announced participation to the demand area power system.

According to a second aspect, there is provided a virtual electrical grid building apparatus connected via a communication network to at least one power transmission/reception unit that comprises a power storage unit and power transmitting and receiving units capable of transmitting and receiving power to/from another power transmission/reception unit via an electrical grid and that is configured to be able to provide power accumulated in the power storage unit to the outside or to be able to accumulate power supplied from the outside; the power transmission/reception unit is adapted to announce participation to a demand area power system via the communication network; and the virtual electrical grid building apparatus controls the power transmission/reception unit so as to provide power to a demand area by building a demand area power system using the power transmission/reception unit that has announced participation to the demand area power system.

According to a third aspect, there is provided at least one power transmission/reception unit comprising a power storage unit and power transmitting and receiving units capable of transmitting and receiving power to/from another power transmission/reception unit via an electrical grid and that is configured to be able to provide power accumulated in the power storage unit to the outside or to be able to accumulate power supplied from the outside; and the power transmission/reception unit is capable of announcing participation to a demand area power system via a communication network to a virtual electrical grid building apparatus that calculates a network configuration of the power transmission/reception units, and has the virtual electrical grid building apparatus build a demand area power system.

According to a fourth aspect, in a demand area power system building system including at least one power transmission/reception unit that comprises a power storage unit and power transmitting and receiving units capable of transmitting and receiving power to/from another power transmission/reception unit via an electrical grid and that is configured to be able to provide power accumulated in the power storage unit to the outside or to be able to accumulate power supplied from the outside and a virtual electrical grid building apparatus connected to the power transmission/reception unit via a communication network, there is provided a demand area power system building method including receiving an announcement of participation to a demand area power system from the power transmission/reception unit via the communication network, and building a demand area power system using the power transmission/reception unit that has announced participation to the demand area power system. The present method is tied to a particular machine, which is a virtual electrical grid building apparatus that builds a demand area power system using a power transmission/reception unit.

According to a fifth aspect, there is provided a program having a computer constituting a virtual electrical grid building apparatus connected via a communication network to at least one power transmission/reception unit that comprises a power storage unit and power transmitting and receiving units capable of transmitting and receiving power to/from another power transmission/reception unit via an electrical grid and that is configured to be able to provide power accumulated in the power storage unit to the outside or to be able to accumulate power supplied from the outside execute receiving an announcement of participation to a demand area power system from the power transmission/reception unit via the communication network, and building a demand area power system using the power transmission/reception unit that has announced participation to the demand area power system. Further, this program can be stored in a computer-readable (non-transient) storage medium. In other words, the present invention can be realized as a computer program product.

According to the present invention, it becomes possible to contribute to expediting and enriching the construction of a demand area power system, especially a demand area power system that does not assume a grid-interconnection to a power feeding system.

### BRIEF DESCRIPTION OF DRAWINGS

FIG. 1 is a drawing showing the configuration of an exemplary embodiment of the present invention.

FIG. 2 is a drawing showing the configuration of a first exemplary embodiment of the present invention.

FIG. 3 is a drawing showing the configuration of a virtual electrical grid building apparatus of the first exemplary embodiment of the present invention.

FIG. 4 is a drawing showing an example of information entries of a power transmission/reception unit database held by the virtual electrical grid building apparatus of the first exemplary embodiment of the present invention.

FIG. 5 is a drawing showing the configuration of the power transmission/reception unit of the first exemplary embodiment of the present invention.

FIG. 6 is a drawing for conceptually explaining the balance of electric power in the power transmission/reception unit of the first exemplary embodiment of the present invention.

FIG. 7 is a sequence diagram for explaining the operation of the first exemplary embodiment of the present invention.

### PREFERRED MODES

First, a summary of an exemplary embodiment of the present invention will be given with reference to the drawings. Note that a drawing reference sign is given to each element as an example in the summary solely for facilitating understanding as a matter of convenience, and it is not intended to limit the present invention to the exemplary embodiments shown in the drawings.

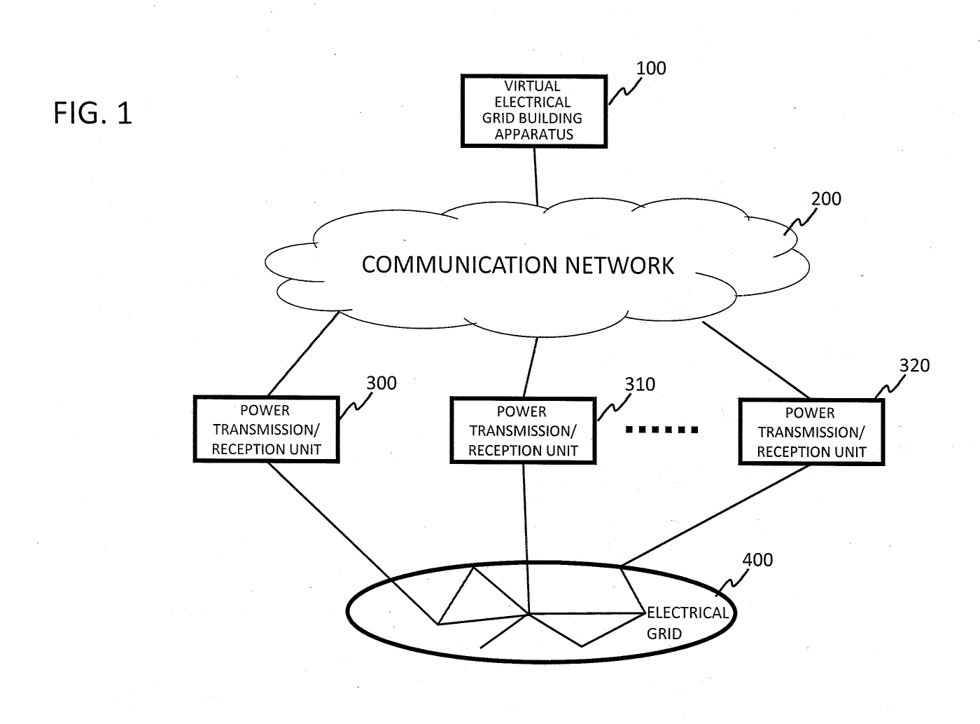

The present invention can be realized in an exemplary embodiment thereof by a configuration in which one or more power transmission/reception units 300 to 320 are connected to a virtual electrical grid building apparatus 100 via a communication network 200, as shown in FIG. 1.

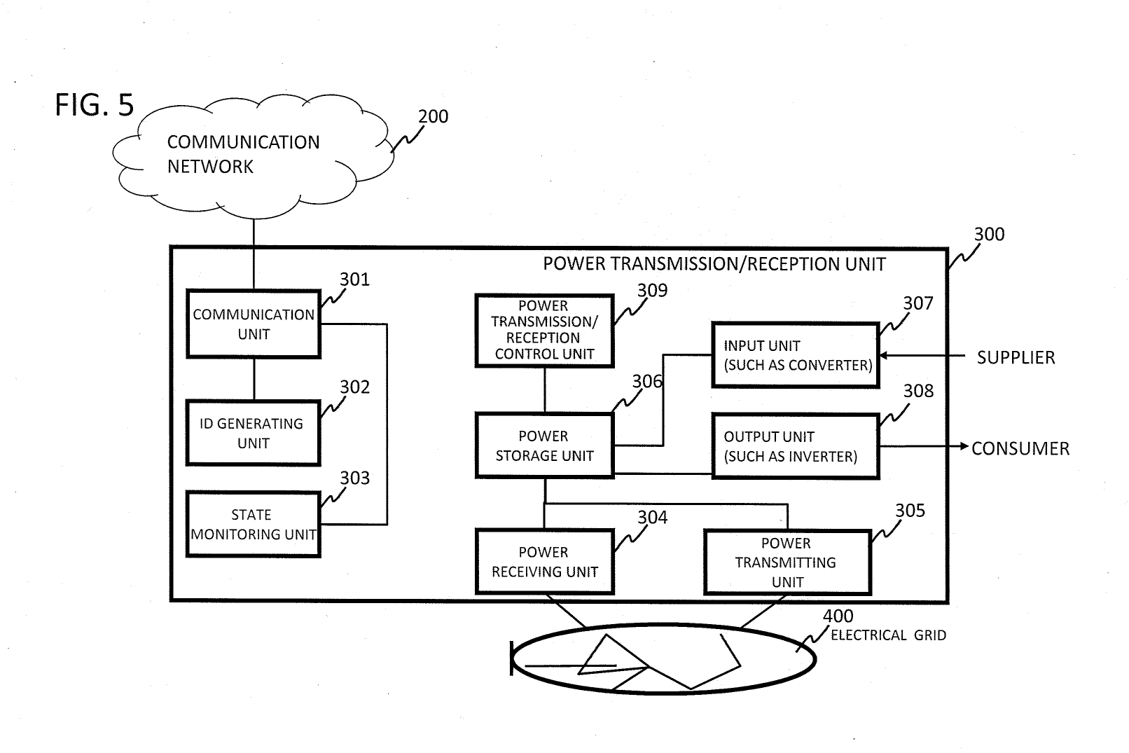

More concretely, each of the power transmission/reception units 300 to 320 comprises a power storage unit (refer to sign 306 in FIG. 5) and power transmitting and receiving units (refer to signs 304 and 305 in FIG. 5) capable of transmitting and receiving power to/from the other power transmission/reception units via an electrical grid 400, and is configured so as to be able to provide power accumulated in the power storage unit to the outside or to store power provided from the outside. Further, the power transmission/reception units 300 to 320 announce their participation to a demand area power system to the virtual electrical grid building apparatus 100 via the communication network 200.

Further, the virtual electrical grid building apparatus 100 calculates power transmission paths using the power transmission/reception units that have announced their participation to a demand area power system, and builds a demand area power system by giving necessary instructions (power transmission paths and power transmission timing) to the power transmission/reception units 300 to 320 on the power transmission paths.

By performing the procedure above, it becomes possible to bring in the virtual electrical grid building apparatus 100 and a required number of the power transmission/reception units 300 to 320 to a disaster or battle area and quickly build a demand area power system. As the power transmission/reception unit, an EV (Electric Vehicle) comprising a battery that functions as the power storage unit can be used. Further, the EV can be equipped with a distributed generator by installing an electric generator (the engine of a so-called hybrid vehicle can also be used) therein.

### Exemplary Embodiment 1

Next, a first exemplary embodiment of the present invention will be described in detail with reference to the drawings. The first exemplary embodiment of the present invention will be described using an example in which a demand area power system is built in a disaster area using an EV and an installation-type PV (PhotoVoltaics).

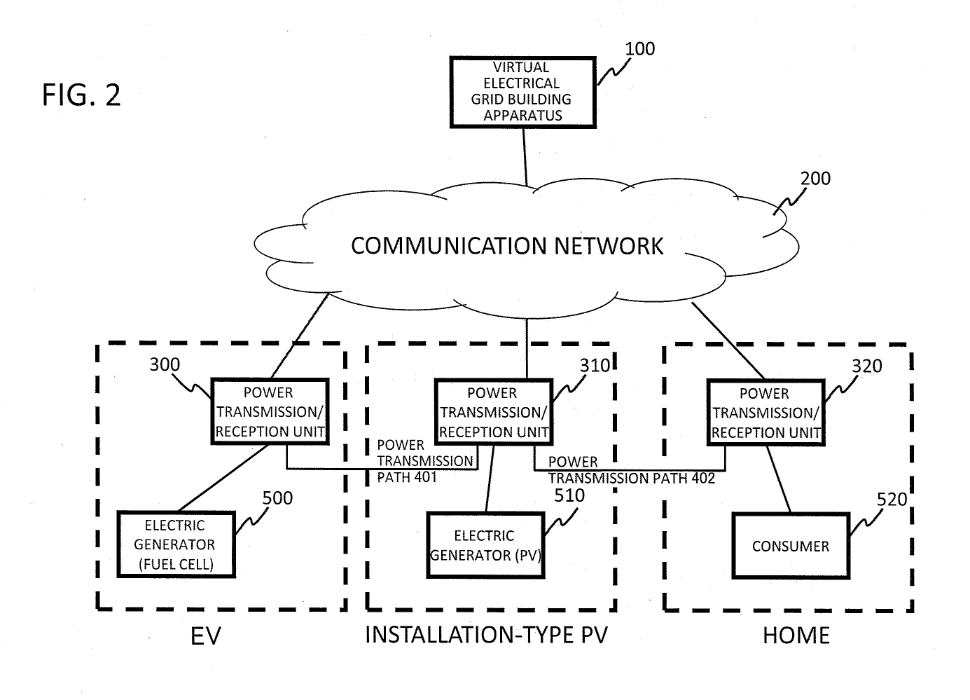

FIG. 2 is a drawing showing the configuration of the first exemplary embodiment of the present invention. FIG. 2 shows a configuration in which the virtual electrical grid building apparatus 100 is provided in the communication network 200. This configuration may be an energy cloud (a virtual network for managing energy configured using a cloud computing technology) on the Internet, or may be achieved by providing the virtual electrical grid building apparatus 100 in a local private network. Note that every power transmission/reception unit in a demand area power system must be connected to a single virtual electrical grid building system. The role of the virtual electrical grid building apparatus 100 is to monitor the state of power transmission/reception units available and existing in the area and to calculate electric power exchange paths and the electric energy. Note that “electric power exchange” in the present exemplary embodiment means flexibly switching the transmission and reception of power between devices and systems.

The communication network 200 can be any network as long as the virtual electrical grid building apparatus 100 and the power transmission/reception unit 300 can communicate with each other, however, since the present exemplary embodiment assumes a demand area power system in a disaster area, a wireless communication network is assumed. A wireless base station normally has an electric power backup using a battery or private generation system and tends to be restored in a relatively short period of time after a disaster. Therefore, it is likely that a wireless network is available in a situation in which a power feeding system is not.

The power transmission/reception units 300, 310, and 320 correspond to nodes constituting the demand area power system. They exchange power and constitute the demand area power system. The power transmission/reception units 300 to 320 function as an entrance of power from suppliers such as a distributed power supply and as an exit of power for supplying power to consumers. At least one power transmission/reception unit is required to constitute a demand area power system. FIG. 2 shows three power transmission/reception units 300, 310, and 320, however, the number of the power transmission/reception units is not limited thereto.

In the example of FIG. 2, an electric vehicle (EV) equipped with an electric generator (fuel cell) 500 is configured as the power transmission/reception unit 300 and transmits power obtained from the electric generator (fuel cell) 500 to the demand area power system. Further, power is supplied to the demand area power system by connecting a photovoltaics system (PV) 510, an installation-type distributed power supply, to the power transmission/reception unit 310. The power transmission/reception unit 320 supplies the power of the demand area power system to a consumer 520.

As described, the power transmission/reception unit 300 using an EV can be utilized as a power transmission/reception unit, which does not have to be a fixed installation. A demand area power system can be built as soon as the vehicle arrives in a disaster area.

The power transmission/reception units are connected to each other in some manner and form a power transmission path to exchange electric power. In the example of FIG. 2, the power transmission/reception units 300 and 310 are connected via a power transmission path 401. The power transmission/reception units 310 and 320 are connected via a power transmission path 402. The connection paths can be of any format, and the virtual electrical grid building apparatus 100 calculates an optimal transmission network, taking the characteristics of the connection path into account. For instance, the power transmission path 401 may be wireless power transmission and the power transmission path 402 may be wired transmission.

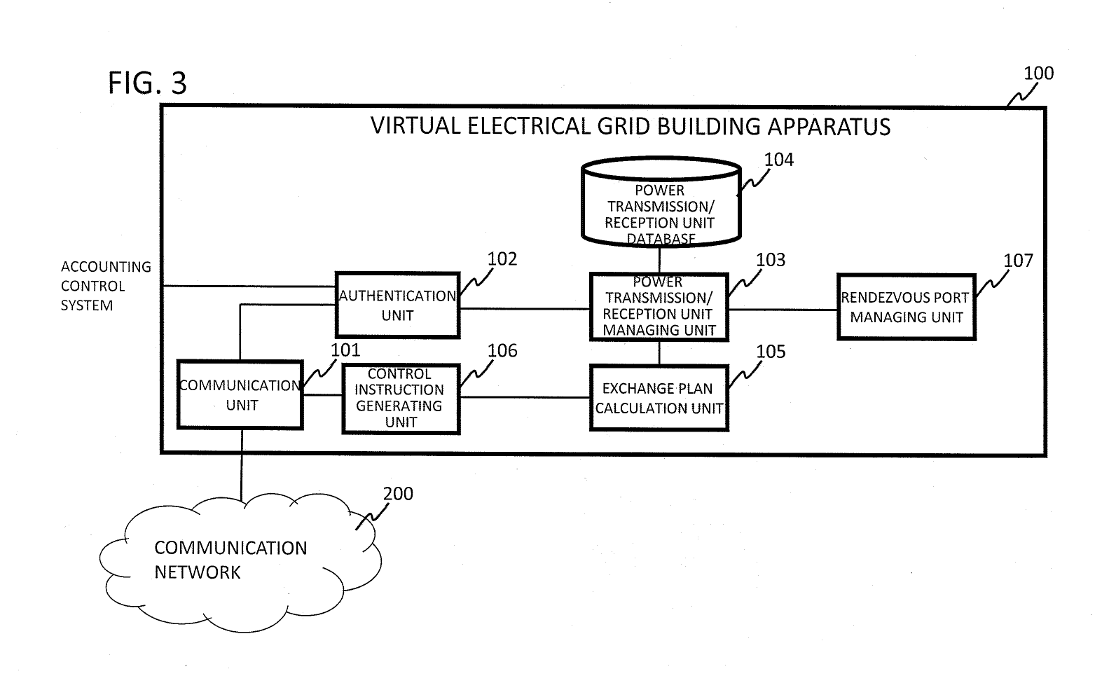

Next, the configuration of the virtual electrical grid building apparatus 100 will be described in detail with reference to the drawings. FIG. 3 is a drawing showing the configuration of the virtual electrical grid building apparatus of the first exemplary embodiment of the present invention. FIG. 3 shows a configuration comprising a communication unit 101, an authentication unit 102, a power transmission/reception unit managing unit 103, a power transmission/reception unit database 104, an exchange plan calculation unit 105, a control instruction generating unit 106, and a rendezvous port managing unit 107.

The communication unit 101 receives a request (corresponding to an announcement of participation to a demand area power system) from a power transmission/reception unit via the communication network 200, and returns a response thereto to the power transmission/reception unit via the communication network 200. The communication unit 101 holds at least one address of the service in the communication network 200 and is able to determine to which demand area power system the announcement of participation has been made using the destination address of the request. Further, a plurality of the virtual electrical grid building apparatuses 100 having different addresses may be provided in the network. A plurality of autonomous demand area power systems can be configured in this case as well.

The authentication unit 102 inspects the request received by the communication unit 101 from the power transmission/reception unit to confirm that it is not an illegal request. Various authentication methods can be used depending on security requirements. For instance, examples include utilizing an electronic certificate or password, and confirming the registration of an ID.

In the example of FIG. 3, the authentication unit 102 works together with an external accounting control system and confirms whether or not the power transmission/reception unit who has sent the request has a valid service contract. Further, the authentication unit 102 is also used to authenticate the external administrator of the virtual electrical grid building apparatus 100. Various authentication methods can be used in this case as well.

The power transmission/reception unit managing unit 103 manages the properties of all the power transmission/reception units included in the demand area power system managed by the service and the topology of the connection paths thereof. Data on the properties and the connection paths is stored in the power transmission/reception unit database (power transmission/reception unit DB) 104 and is suitably updated by the power transmission/reception unit managing unit 103. Further, the power transmission/reception unit managing unit 103 provides a search interface of the data stored in the power transmission/reception unit database 104.

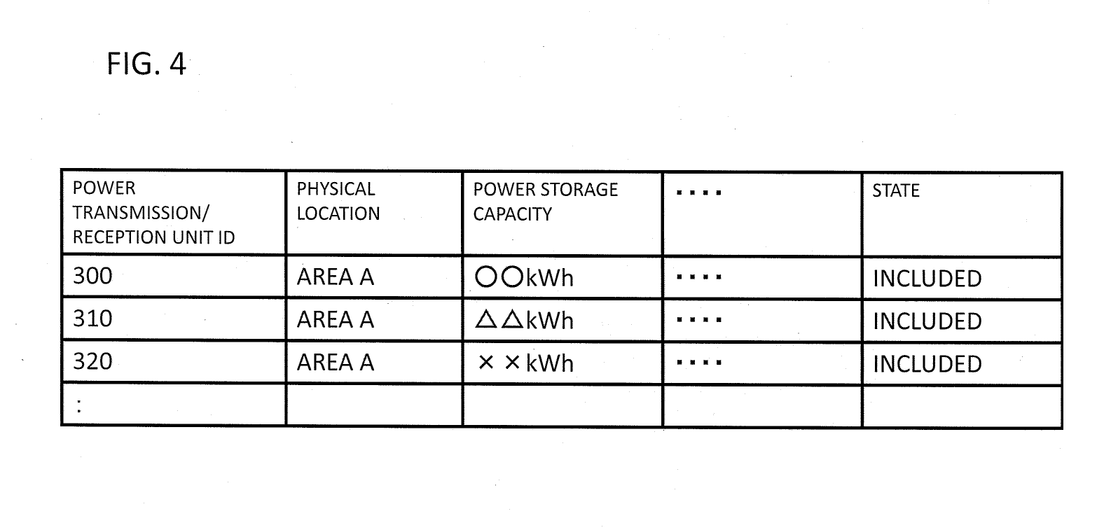

The data stored in the power transmission/reception unit database (power transmission/reception unit storage unit) 104 includes the properties of each power transmission/reception unit such as ID information and physical location, and capability information such as power storage capacity (free capacity), power storage efficiency, input/output specifications, and input/output efficiency. Further, the power transmission/reception unit database 104 may retain the characteristics of a power transmission path directly connected to each power transmission/reception unit, exchange plan instructions (described later), and other pieces of management information required for the service, included in the capability information. FIG. 4 is a drawing showing an example of information entries held by the power transmission/reception unit database.

The exchange plan calculation unit 105 checks the power storage capacity of each power transmission/reception unit on a regular basis and creates a power exchange plan. The exchange plan calculation unit 105 uses the information of “all the available power transmission/reception units belonging to the demand area power system” and the path information managed by the power transmission/reception unit managing unit 103.

When a power exchange is deemed necessary between the power transmission/reception units as a result of calculation by the exchange plan calculation unit 105, the exchange plan calculation unit 105 instructs the control instruction generating unit 106 to create a power exchange instruction (instructing the units to transmit power to each other) in a format suitable to each power transmission/reception unit. Further, the control instruction generating unit 106 stores an “exchange plan instruction” in the power transmission/reception unit database 104 via the power transmission/reception unit managing unit 103.

The rendezvous port managing unit 107 is a function for having the power transmission/reception units that exchange power with each other safely communicate with each other. By having the virtual electrical grid building apparatus 100 as a rendezvous point, the power transmission/reception units are able to communicate with each other even in a situation in which they cannot do so directly (for instance when there is a firewall therebetween). Further, since the virtual electrical grid building apparatus 100 authenticates the IDs of the power transmission/reception units, it can be guaranteed that the power transmission/reception units are dealing with legitimate units (trustworthy communication partner). In other words, the trust relationship between the units is guaranteed by the virtual electrical grid building apparatus 100 and the authentication of the power transmission/reception units.

Next, the configuration of the power transmission/reception unit will be described in detail with reference to the drawings. FIG. 5 is a drawing showing the configuration of the power transmission/reception unit 300 of the first exemplary embodiment of the present invention. FIG. 5 shows a configuration comprising a communication unit 301, an ID generating unit 302, a state monitoring unit 303, the power receiving unit 304, the power transmitting unit 305, the power storage unit 306, an input unit (such as a converter) 307, an output unit (such as an inverter) 308, and a power transmission/reception control unit 309. Since the power transmission/reception units 310 and 320 are basically configured identically to the power transmission/reception unit 300, the explanation will be omitted.

The communication unit 301 is used to communicate with the virtual electrical grid building apparatus 100 via the communication network 200. Further, unlike the virtual electrical grid building apparatus 100, the power transmission/reception unit 300 does not need a fixed address (it may have a temporary address such as one of DHCP (Dynamic Host Configuration Protocol)).

Further, the communication unit 301 stores the address of the virtual electrical grid building apparatus 100, the communication partner. The address of the virtual electrical grid building apparatus 100 may be entered and set when the operation of the power transmission/reception unit starts, or it may be obtained from a predetermined server afterwards.

In a case where an IP network is used, it is necessary to hold basic information for a network terminal such as a gateway address, the address of the proxy server (if there is a firewall), and a DNS address (if name resolution is necessary).

The ID generating unit 302 generates the ID number of the power transmission/reception unit. Various formats may be used for the ID number. Examples include the serial number set at the factory, the ID of the owner of the power transmission/reception unit, and location information (latitude/longitude, address, apartment number, etc.) of a consumer or supplier. The ID information is transmitted to the virtual electrical grid building apparatus 100 by the communication unit 301 and is authenticated by the authentication unit 102. Therefore, the ID number generated by the ID generating unit 302 must be a unique number that the virtual electrical grid building apparatus 100 can understand so as to distinguish the unit from the other power transmission/reception units. Further, the power transmitting unit 305 uses the ID number to discover a direct path to the power transmission/reception unit by transmitting it to the electrical grid.

The state monitoring unit 303 monitors various states of the unit. More concretely, the monitored states include the electric energy (free/remaining capacity) and aging situation of the power storage unit, the electric energy received by the power receiving unit 304, the electric energy transmitted by the power transmitting unit 305, the locally generated electric energy obtained from the input unit 307, and power consumed via the output unit 308. These pieces of data are transmitted to the virtual electrical grid building apparatus 100 along with the ID of the power transmission/reception unit via the communication unit 301, and are ultimately stored in the power transmission/reception unit database 104. At this time, a power exchange plan of the power transmission/reception unit is obtained, accompanying an ACK response from the virtual electrical grid building apparatus 100.

The power transmission/reception unit has zero or more power receiving units 304, which receive power transmitted by the other power transmission/reception units and stores it in the power storage unit 306. Further, via the same route, the power receiving unit 304 obtains the ID information of the power transmission/reception unit transmitting power. A single power receiving unit 304 may be responsible for a plurality of power transmission paths (receiving power from a plurality of the power transmission/reception units). In this case, each path can be recognized.

The power transmission/reception unit has zero or more power transmitting units 305, which transmit power to the other power transmission/reception units. Further, the power transmitting unit 305 transmits the ID information thereof via the same route. A single power transmitting unit 305 may be responsible for a plurality of power transmission paths (transmitting power to a plurality of the power transmission/reception units). In this case, the power transmitting unit 305 can recognize each path.

The power storage unit 306 stores power obtained from the power receiving unit 304 and the input unit 307. The stored power is supplied from the output unit 308 to a consumer and is consumed. Or it is transmitted to the other power transmission/reception units (the demand area power system) via the power transmitting unit 305. Various formats may be used for the power storage unit 306. Examples of the power storage unit include cases where an independent secondary battery is used, a storage battery managed by an HEMS (Home Energy Management System) or electric vehicle (EV) is utilized, inertial energy such as a flywheel is utilized, and large-scale facilities such as a water pump is utilized. In any case, anything available in the demand area and suitable to the environment of the demand area should be selected and used. Note that the charge rate, the output characteristics, and the maximum storage capacity will depend on the format of the power storage unit 306. The state monitoring unit 303 may store these pieces of the characteristic information as data and transmit the data to the virtual electrical grid building apparatus 100. In this case, the virtual electrical grid building apparatus 100 can use the characteristic information when calculating power exchange plans.

The input unit 307 is constituted by a converter, connected to a supplier such as a power supply device, that stores supplied power in the power storage unit 306. The connected device can be anything as long as it is capable of supplying power. For instance, a distributed generator such as a photovoltaics system (PV), wind power generator, and fuel cell can suitably be utilized. It goes without saying that the utilization of a power feeding system or digital grid router (DGR) is not excluded. When the capacity of the power storage unit 306 is full and the other power transmission/reception units in the demand area power system cannot receive power, either, because their capacity is full as well, the input unit 307 cuts off input power and controls so that the power transmission/reception unit does not get damaged.

The output unit 308 is constituted by an inverter that draws power from the power storage unit 306 and supplies it to a consumer. When the power storage 306 does not have sufficient accumulated power or the output requirements exceed the specifications of the output unit 308, the output unit 308 controls so as not to damage the power transmission/reception unit such as cutting off the output power.

The power transmission/reception control unit 309 controls the power receiving and transmitting units 304 and 305 to exchange power with the other power transmission/reception units on the basis of the power exchange plan that the state monitoring unit 303 has acquired from the virtual electrical grid building apparatus 100. At this time, the power transmission/reception control unit 309 connects to a rendezvous port of the virtual electrical grid building apparatus 100 via the communication unit 301 and is able to perform processing while keeping pace using the rendezvous port with the power transmission/reception control unit 309 of the power transmission/reception unit with which power is exchanged.

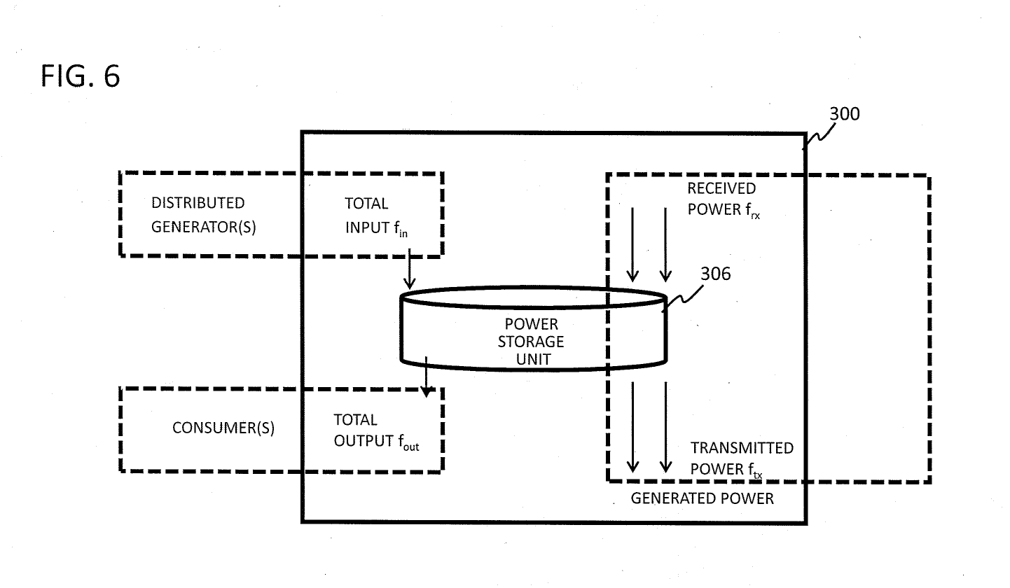

As supplementary information to the configuration of the power transmission/reception unit 300, the balance of electric power in the power transmission/reception unit 300 will be conceptually described with reference to FIG. 6.

The power transmission/reception unit 300 accumulates total input fᵢₙ provided by distributed generation and power provided from received power fᵣₓ received from the other power transmission/reception units, having the power storage unit 306 as its core. At the same time, the power transmission/reception unit 300 outputs the accumulated power through two paths: total output fₒᵤₜ supplied to a consumer and transmitted power fₜₓ transmitted to the other power transmission/reception units.

The received power fᵣₓ and the transmitted power fₜₓ represent the power exchange paths between the power transmission/reception units, and by connecting a plurality of the power transmission/reception units, a demand area power system is constituted by the virtual electrical grid building apparatus 100.

The total input fᵢₙ is power supplied from a distributed generator(s) to the demand area power system. The total output fₒᵤₜ is power supplied to a consumer(s) from the demand area power system.

In the conventional methods for configuring a demand area power system, electrical grids are fixed and grid interconnection and ring topology are assumed. As for power exchange, some methods called digital grids consider exchanges between electrical grids (between cells). Further, there is a consumer/supplier collaborative system in which the voltage of an electrical grid is maintained within a predetermined range by linking input at a point in the electrical grid and output at another point. The present exemplary embodiment is fundamentally different from these systems in the sense that the electrical grid of the demand area power system can be dynamically configured as shown in the conceptual diagram of FIG. 6.

Further, out of each unit (processing means) of the virtual electrical grid building apparatus 100 and the power transmission/reception units 300 to 320 shown in FIGS. 3 and 5, ones that can be implemented by an information processing technology can be realized by a computer program having a computer that constitutes these devices execute each processing described above using the hardware thereof.

Next, the operation of the present exemplary embodiment will be described in detail with reference to the drawings. The operation will be described in the order below.

1. The services provided by the virtual electrical grid building apparatus and the operation thereof.
2. The power transmission operation between the power transmission/reception units
3. The overall operation of the system
1. The services provided by the virtual electrical grid building apparatus and the operation thereof.
The virtual electrical grid building apparatus 100 provides the following services.
1.1. Service of registering the power transmission/reception units
1.2. Service of monitoring the power transmission/reception units
1.3. Rendezvous service for the power transmission/reception units
1.4. Service of remotely controlling the virtual electrical grid
1.5. Service of planning power exchanges for the virtual electrical grid

### 1.1. Service of Registering the Power Transmission/Reception Units

The virtual electrical grid building apparatus 100 receives a registration request from the power transmission/reception units (an announcement of participation to the demand area power system).

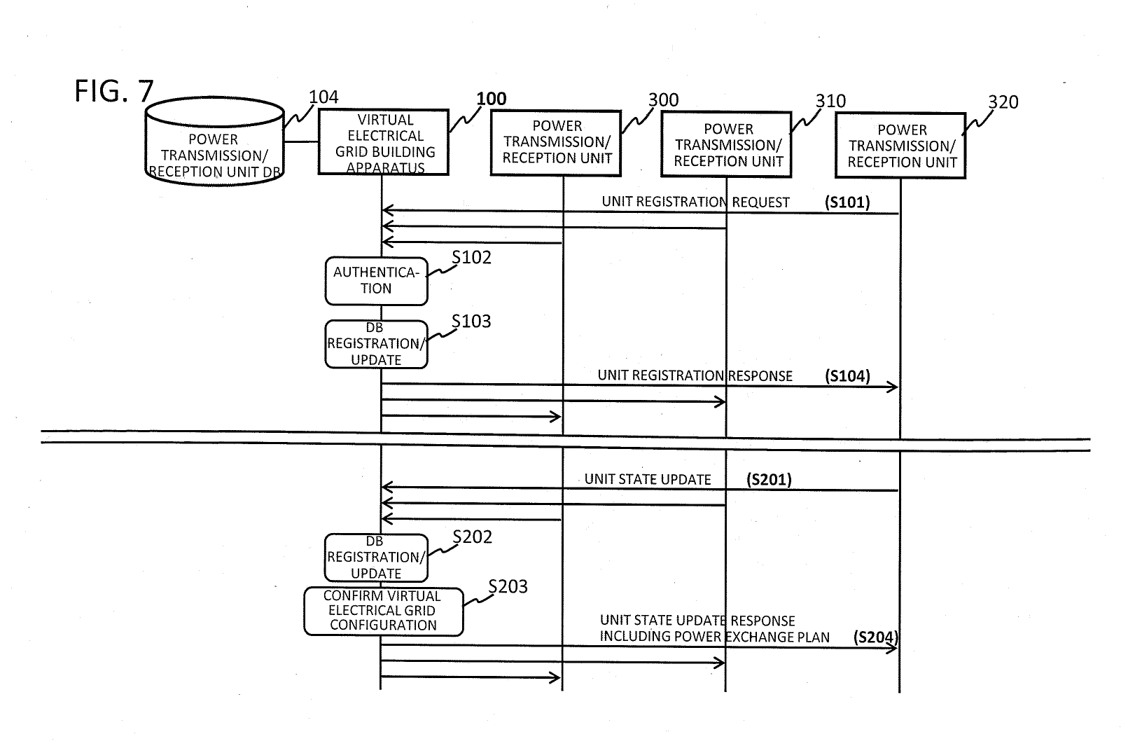

FIG. 7 is a sequence diagram showing the operation of the virtual electrical grid building apparatus 100. As shown in FIG. 7, the processing of registering a power transmission/reception unit starts when the communication unit 101 of the virtual electrical grid building apparatus 100 receives a “unit registration request” from the power transmission/reception units 300 to 320 via the communication network 200 (step S101). The unit registration request includes the properties of the power transmission/reception unit such as the ID information, the physical location, the power storage capacity (free capacity), the power storage efficiency, the input/output specifications and the input/output efficiency, and the information of the power transmission paths directly connected to this power transmission/reception unit.

After access control is performed (such as ignoring a request from an illegal address) and the authentication unit 102 confirms that the request source has the right to register the unit (step S102), the communication unit 101 forwards the received unit registration request to the power transmission/reception unit managing unit 103.

The power transmission/reception unit managing unit 103 refers to the power transmission/reception unit database 104. When the power transmission/reception unit that is the source of the unit registration request has been already registered in the power transmission/reception unit database 104 and has been disconnected by a system administrator of the remote control service of the virtual electrical grid (when the unit is flagged as such in the database), the power transmission/reception unit managing unit 103 rejects the unit registration request.

When the power transmission/reception unit that is the source of the unit registration request has been already registered in the power transmission/reception unit database 104, but the unit is not disconnected, the power transmission/reception unit may be serviced or restarted. In this case, the power transmission/reception unit managing unit 103 updates the database information on the basis of the information included in the unit registration request (step S103). Further, when there is a power exchange plan applicable to the corresponding power transmission/reception unit, the power transmission/reception unit managing unit 103 cancels the power exchange plan. Further, the power transmission/reception unit managing unit 103 releases the rendezvous port reserved for the exchange plan The power exchange plan may have been accepted by the partner power transmission/reception unit and the power exchange may have been started depending on the timing, however, the power exchange can be cancelled by releasing the rendezvous port since power exchanges are performed by a collaborative operation between the power transmission/reception units using a rendezvous port.

When the power transmission/reception unit that is the source of the unit registration request has not been registered in the power transmission/reception unit database 104, the power transmission/reception unit managing unit 103 registers the information included in the unit registration request in the power transmission/reception unit database 104 (the step S103).

Further, when registering and updating the information in the power transmission/reception unit database 104, the power transmission/reception unit managing unit 103 inspects whether or not the information included in the unit registration request has any abnormality. For instance, if a contradiction may occur in the electrical grid or the power transmission path directly loops back to itself, the power transmission/reception unit managing unit 103 rejects the unit registration request, treating it as abnormal data.

After the above processing has completed, the power transmission/reception unit managing unit 103 returns a response (success/rejection) to the registration request by the power transmission/reception unit to the power transmission/reception unit via the communication unit 101 (step S104). When the registration of the power transmission/reception unit is rejected, the reason may be sent to the power transmission/reception unit as well.

Having received the response to the unit registration request, the power transmission/reception units 300 to 320 are in a state of “being included” in the virtual electrical grid. In the present exemplary embodiment, however, they cannot participate in power exchanges at this point of time for the sake of security. In order to participate in power exchanges thereafter, the administrator must confirm the state of the power transmission/reception unit in “1.4 Service of remotely controlling the virtual electrical grid” described later and change the state of the power transmission/reception unit from “being included” to “being able to exchange power.” After this has been set, the power transmission/reception unit is included in power exchange calculation in a next monitoring cycle (refer to 1.2 monitoring service). Depending on the properties of the power transmission/reception unit and system requirements, it may be changed from “being included” to “being able to exchange power” automatically.

### 1.2. Service of Monitoring the Power Transmission/Reception Units

As a monitoring service, the virtual electrical grid building apparatus 100 autonomously reconfigures the state of the virtual electrical grid using the following method. The power transmission/reception unit managing unit 103 confirms the state of the power transmission/reception units stored in the power transmission/reception unit database 104 on a regular basis (for instance every minute) and reviews the configuration of the virtual electrical grid.

More concretely, the power transmission/reception units 300 to 320 registered in the virtual electrical grid building apparatus 100 transmits the state of its own unit to the virtual electrical grid building apparatus 100 at a predetermined interval (for instance 10 minutes) using a “unit state update request” (step S201 in FIG. 7). As a result, the state of the power transmission/reception unit database 104 is updated (step S202), and then the power transmission/reception units 300 to 320 obtain a next power exchange plan included in the response from the virtual electrical grid building apparatus 100 (steps S203 and S204). The power transmission/reception unit managing unit 103 uses the system of the unit state update request to confirm surviving power transmission/reception units. In other words, when the information of a power transmission/reception unit in the power transmission/reception unit database 104 has not been updated for a long period of time (for instance 30 minutes), the power transmission/reception unit managing unit 103 deems this power transmission/reception unit nonexistent, disconnects it from the virtual electrical grid, and deletes the information from the power transmission/reception unit database 104. Further, this power transmission/reception unit can be included in the system again by sending a “unit registration request” to the virtual electrical grid building apparatus 100 after being restored.

Further, in a case where a serious abnormality (for instance a failure of the power storage unit 306) of a power transmission/reception unit is recorded in the power transmission/reception unit database 104, the power transmission/reception unit managing unit 103 does not delete the power transmission/reception unit from the power transmission/reception unit database 104, but it disconnects the unit from the virtual electrical grid. If a next “unit state update request” reports that the issue has been normalized, the power transmission/reception unit managing unit 103 will include the unit in the virtual electrical grid again in next configuration review.

A power transmission abnormality in a power transmission path between the power transmission/reception units is recognized as an abnormality of the power receiving unit 304 and the power transmitting unit 305 of the power transmission/reception units, and is recorded in the power transmission/reception unit database 104 with a “unit state update request.” The abnormal power transmission path is disconnected from the virtual electrical grid. If a next “unit state update request” reports that the problematic path has been normalized, the power transmission/reception unit managing unit 103 will include the path in the virtual electrical grid again in next configuration review.

Further, a “unit withdrawal request” may sometimes arrive from a power transmission/reception unit approved by the authentication unit 102 and having a valid entry in the power transmission/reception unit database 104. In this case, the power transmission/reception unit managing unit 103 deletes the corresponding entry from the power transmission/reception unit database 104 in order to remove the applicable power transmission/reception unit from the virtual electrical grid. The power transmission/reception unit managing unit 103 does not include this power transmission/reception in the virtual electrical grid unit until a “unit registration request” is received again. If any power exchange plan or rendezvous port involving the power transmission/reception unit exists, the power transmission/reception unit managing unit 103 deletes them all. Even if there is an ongoing power exchange task, any power exchange involving the power transmission/reception unit will be stopped since the rendezvous port is deleted.

### 1.3. Rendezvous Service for the Power Transmission/Reception Units

When two power transmission/reception units exchange power, the virtual electrical grid building apparatus 100 provides a communication port using the rendezvous port managing unit 107 so that the units can keep pace with each other.

First, the power transmission/reception unit obtains a power exchange plan as the response to a “unit sate update request” from the virtual electrical grid building apparatus 100.

The power transmission/reception unit sends a “rendezvous port open request” to the virtual electrical grid building apparatus 100 at a time specified in the power exchange plan.

The virtual electrical grid building apparatus 100 has the authentication unit 102 confirm the legitimacy of the request source power transmission/reception unit and then processes the “rendezvous port open request” using the rendezvous port managing unit 107.

The rendezvous port managing unit 107 asks the power transmission/reception unit managing unit 103 to confirm that the power transmission/reception unit database 104 has a power exchange plan involving the request source. Here, if no corresponding plan exists, the rendezvous port managing unit 107 notifies the power transmission/reception unit that the “rendezvous port open request” has been rejected. At this time, the reason for rejection is “no corresponding power exchange plan.” If the power transmission/reception unit database 104 has a corresponding power exchange plan, the rendezvous port managing unit 107 confirms whether or not the partner power transmission/reception unit has already opened any port.

When the partner power transmission/reception unit has already opened a port for power exchange, the rendezvous port managing unit 107 notifies the request source power transmission/reception unit of the port information already described and of the fact that the partner is already waiting as a response. Further, the rendezvous port managing unit 107 notifies the partner power transmission/reception unit who opened the port of the fact that the port has been notified.

If no port has been opened for the power exchange, the rendezvous port managing unit 107 secures a new port. Further, the rendezvous port managing unit 107 records port information in the power transmission/reception unit database 104 via the power transmission/reception unit managing unit 103, newly opens a port for the request source power transmission/reception unit, and notifies the unit that a partner power transmission/reception unit does not exist yet.

In addition, the rendezvous port managing unit 107 operates as a proxy server for the communication performed thereafter between the power transmission/reception units to exchange power. In other words, the rendezvous port managing unit 107 monitors the communication between the power transmission/reception units and behaves as a communication partner as if the virtual electrical grid building apparatus 100 were the power transmission/reception unit involved in exchanging power. By monitoring the communication, the rendezvous port managing unit 107 detects a sudden failure of the power transmission/reception units or any malicious access, and enforces disconnection by releasing the rendezvous port when there is harmful communication for the system.

### 1.4. Service of Remotely Controlling the Virtual Electrical Grid

The virtual electrical grid building apparatus 100 provides the following functions for the administrator to externally manage the virtual electrical grid.
Browsing the virtual electrical grid
Displaying the state of a power transmission/reception unit
Disconnecting, reconnecting, and removing a power transmission/reception unit to/from the virtual electrical grid
Canceling power exchange plan
Displaying a log of power exchanges and system operation

In all the operations above, the administrator externally accesses the virtual electrical grid building apparatus 100 via the communication network.

A request from the administrator is received by the communication unit 101 and then authenticated by the authentication unit 102. The request is discarded unless it is from a valid administrator. When it is from a valid administrator, the request is sent to the power transmission/reception unit managing unit 103.

When receiving a request to browse the virtual electrical grid, the power transmission/reception unit managing unit 103 returns a list of all the power transmission/reception units currently registered in the power transmission/reception unit database 104 along with the state of each power transmission/reception unit.

When receiving a request to display the state of a power transmission/reception unit, the power transmission/reception unit managing unit 103 takes out the information of the power transmission/reception unit having the specified ID from the power transmission/reception unit database 104 and returns the information. When the specified power transmission/reception unit does not exist, the power transmission/reception unit managing unit 103 responds with a message saying, “It does not exist.”

When receiving a request from a power transmission/reception unit to be disconnected from the virtual electrical grid, the power transmission/reception unit managing unit 103 changes the state of the power transmission/reception unit to a state of “disconnected” in a case where there is the power transmission/reception unit having the specified ID in the power transmission/reception unit database 104. The power transmission/reception unit in the disconnected state is not included in power exchange plans thereafter. If the power transmission/reception unit is included in the virtual electrical grid, the power transmission/reception unit managing unit 103 confirms whether or not any rendezvous port has been secured for the power transmission/reception unit by referring to the power transmission/reception unit database 104 in order to put the power transmission/reception unit in the state of “disconnected.” If a rendezvous port secured for the power transmission/reception unit is found as a result of the confirmation, the power transmission/reception unit managing unit 103 deletes the rendezvous port. Once disconnected, the power transmission/reception unit remains so until it is reconnected (described later) or removed (described later). When receiving a request from a power transmission/reception unit to be reconnected to the virtual electrical grid, in a case where the power transmission/reception unit having the specified ID exists in the power transmission/reception unit database 104 and the unit is in the state of “disconnected,” the power transmission/reception unit managing unit 103 cancels this state. As a result of the cancellation, the power transmission/reception unit will be included in the virtual electrical grid unless it has an abnormality and will be included in next power exchange plan calculation.

When receiving a request from a power transmission/reception unit to be deleted from the virtual electrical grid, the power transmission/reception unit managing unit 103 searches for the power transmission/reception unit having the specified ID in the power transmission/reception unit database 104 and deletes it from the power transmission/reception unit database 104. Further, when there is a rendezvous port involving the power transmission/reception unit to be deleted, the power transmission/reception unit managing unit 103 deletes the port as well. In order for this power transmission/reception unit to be included in the virtual electrical grid, the power transmission/reception unit must send a “power transmission/reception unit registration request” to the virtual electrical grid building apparatus 100 and the registration must be successful (refer to S101 in FIG. 7 and beyond).

When receiving a request to cancel a power exchange plan, the power transmission/reception unit managing unit 103 is able to select two power transmission/reception units performing a power exchange from the power transmission/reception unit database 104 on the basis of the IDs of the power transmission/reception units and cancel a particular power exchange plan therebetween. The power exchange plan is identified by using the IDs of the two power transmission/reception units and a time and ID identifying the power exchange plan. More concretely, when the power exchange plan is found as a result of referring to the power transmission/reception unit database 104, the cancellation is performed by deleting the information thereof. Further, when there is any related rendezvous port, the power transmission/reception unit managing unit 103 release it as well. When the specified power exchange plan does not exist, the power transmission/reception unit managing unit 103 responds with an error message stating so to the request source.

When receiving a request to display a log of power exchanges and the system operation, the power transmission/reception unit managing unit 103 refers to the power transmission/reception unit database 104, acquires information obtained from a particular power transmission/reception unit, a communication log between the virtual electrical grid building service and the power transmission/reception unit, and state change events of the power transmission/reception unit, and responds.

### 1.5. Service of Planning Power Exchanges for the Virtual Electrical Grid

The virtual electrical grid building apparatus 100 calculates power to be exchanged over the network (the virtual electrical grid) of the power transmission/reception units built and updated on a regular basis by the service of monitoring the power transmission/reception units, and devises a plan. The plan is devised by the exchange plan calculation unit 105. The devised plan is stored in the power transmission/reception unit database 104 via the power transmission/reception unit managing unit 103. This is because the network of the power transmission/reception units may change during the process of storing the plan. By having all the updates on the power transmission/reception unit database go through the power transmission/reception unit managing unit 103, state updates can be performed without any conflict.

The exchange plan calculation unit 105 determines the capacity of the virtual electrical grid by performing the following calculations for all the power transmission paths of the virtual electrical grid and for all the power transmission/reception units. First, the exchange plan calculation unit 105 determines the maximum power Pₚₐₛₛ [path] that can flow in the power transmission paths from the state of the power transmission paths between the power transmission/reception units. The state of the power transmission path is reported by each power transmission/reception unit and can be grasped from the contents registered in the power transmission/reception unit database 104. Next, the exchange plan calculation unit 105 calculates the maximum power amount Wₜₒₜₐₗ [unit] that can be sent to a particular power transmission/reception unit from the free capacity of the power storage unit 306 of the power transmission/reception unit and a rate prediction of the total input fᵢₙ and the total supply fₒᵤₜ at a next unit time. Since the total sum of a value obtained by multiplying the power amount that can flow in the power transmission path to the power transmission/reception unit by an efficiency prediction P_{eff} [path] for each power transmission path at this time and the unit time cannot exceed the maximum power amount Wₜₒₜₐᵢ that can be sent to the power transmission/reception unit, the power exchange plan must be devised while meeting this constraint.

### [Constraint in Devising a Power Exchange Plan]

Σ all the paths(Pₜₒₜₐₗ[path]*P_{eff}[path]*unit time)<Wₜₒₜₐₗ[unit]

Next, the exchange plan calculation unit 105 devises a power exchange plan for the entire virtual electrical grid with the following calculation. Since power transmission for a power exchange incurs an energy loss, it is better not to exchange power if the total input fᵢₙ and the total supply fₒᵤₜ of each power transmission/reception unit are balanced. First, the need for a power exchange is confirmed for all the power transmission/reception units. More concretely, each power transmission/reception unit is assigned to three different modes.

### [Power Transmitting Mode]

In the power transmission mode, power is transmitted to the other power transmission/reception units. When fᵢₙ+fᵣₓ is much greater than fₒᵤₜ+fₜₓ in FIG. 6 ((fᵢₙ+fᵣₓ)−(fₒₒₜ+fₜₓ)>Tₜₓ where Tₜₓ is the power transmission threshold value) and the power storage unit is expected to be full in the near future with input power to be thrown away, the exchange plan calculation unit 105 determines that the unit must “transmit power.” Note that at the beginning of the calculation fᵣₓ and fₜₓ are put equal to 0.

### [Power Receiving Mode]

In the power receiving mode, the unit receives power from the other power transmission/reception units. When fₒᵤₜ+fₜₓ is much greater than fᵢₙ+fᵣₓ (fₒᵤₜ−fᵢₙ>Tᵣₓ where Tᵣₓ is the power reception threshold value) and the power storage unit is expected to be empty in the near future, being unable to supply power to consumers, the exchange plan calculation unit 105 determines that the unit must “receive power.” Note that at the beginning of the calculation fᵣₓ and fₜₓ are put equal to 0.

### [Standby Mode]

In the standby mode, which is different from the power transmitting mode or the power receiving mode, the unit does not exchange power with the other power transmission/reception units. In other words, the total (balance) of fᵢₙ and fₒᵤₜ is balanced within a predetermined range.

Further, since when a power transmission/reception unit in the standby mode should be put in the power transmitting mode or the power receiving mode depends on the properties such as the capacity and the remaining capacity of the power storage unit 306, the threshold values Tₜₓ and Tᵣₓ are set in each power transmission/reception unit and the values are registered in the power transmission/reception unit database 104 on a regular basis. For instance, a power transmission/reception unit with the remaining capacity of the power storage unit 306 being less than 5% reports “Tᵣₓ=0” to the virtual electrical grid building service so as to be always put in the power receiving mode when fₒᵤₜ>fᵢₙ. Similarly, a power transmission/reception unit that has just been connected to the virtual electrical grid may report a negative Tᵣₓ number so as to be put in the power receiving mode even with Gₒᵤₜ=0. Each power transmission/reception unit can be intelligent as described.

Finally, a power transmission plan is devised for each power transmission/reception unit. The basic concept of planning is to prioritize meeting the needs of consumers in step 1, and then to store surplus power as much as possible in step 2.

In these two steps, a predicted power supply remaining time table Tᵣₑₘₐᵢₙ [power transmission/reception unit] is utilized. As the predicted power supply remaining time table Tᵣₑₘₐᵢₙ [power transmission/reception unit], what the power transmission/reception units have registered in the power transmission/reception unit database 104 in advance can be utilized. The predicted remaining time can be roughly derived by the following calculation. The remaining capacity of the power storage unit 306 is divided by the most recent prediction of the total outflow power (=fₒᵤₜ+fₜₓ−fᵢₙ−fᵣₓ). Then by also taking into account the input/output characteristics of the power storage unit 306 (such as that power suddenly drops after a certain amount of discharge, etc.), how many more minutes the power transmission/reception unit will be able to supply necessary power to a consumer can be derived. The power transmission planning using Tᵣₑₘₐᵢₙ [power transmission/reception unit] will be described below.

Step 1: Meeting the Need of Consumers

The exchange plan calculation unit 105 sorts a list of the power transmission/reception units in the power receiving mode with the predicted remaining time derived using Tᵣₑₘₐᵢₙ [power transmission/reception unit], and select a power transmission/reception unit E having the shortest predicted remaining time. Then, to meet the demand of the power transmission/reception unit, a power exchange from an adjacent power transmission/reception unit is planned to an extent that the capacity of the power transmission path allows, and the mode of the power transmission/reception unit is recalculated with this exchange taken into account.

When there is a plurality of power transmission/reception units adjacent to the power transmission/reception unit E, a power exchange is planned from the power transmission/reception unit having the longest predicted remaining time out of the power transmission/reception units in the power transmitting mode to an extent that the capacity of the path allows. If a plurality of power transmission/reception units have comparable predicted remaining times, power transmission from a power transmission/reception unit connected to a path with high power transmission efficiency will be prioritized.

When the power transmission/reception unit E does not get into the standby mode (remains in the power receiving mode) even after power has been exchanged from all the power transmission/reception units in the power transmitting mode and the mode has been recalculated, a power exchange is similarly planned from an adjacent power transmission/reception unit in the standby mode and the mode of the power transmission/reception unit E is recalculated.

When the power transmission/reception unit E does not get into the standby mode even after power has been exchanged from all the power transmission/reception units in the power transmitting mode and the standby mode and the mode has been recalculated, a power exchange is similarly planned from an adjacent power transmission/reception unit in the power receiving mode. Although it seems pointless to have the power transmission/reception units in the power receiving mode exchange power, the reason for this is that there may be a power transmission/reception unit in the power transmitting mode further ahead and power may be able to exchanged in a multi-hop manner. However, power transmission/reception units for which power exchanges have been planned already are excluded.

When the power transmission/reception unit E still remains in the power receiving mode even after power is supplied by all the adjacent power transmission/reception units as described above, it means that the current fᵢₙ+fᵣₓ does not meet the need of consumers and power exchanges cannot address it. In this case, the exchange plan calculation unit 105 extends the predicted remaining time as much as possible according to the devised power exchange plan and waits for the supply and demand situation of power to get better in the meantime. If the situation does not improve, the remaining capacity of the power storage unit 306 will become zero and the output unit will stop supplying power. This event will be transmitted to the virtual electrical grid building apparatus 100 with a regular state report from the power transmission/reception unit, and the monitoring service will take necessary actions (such as notifying the administrator).

Finally, the exchange plan calculation unit 105 has the control instruction generating unit 106 convert the calculated power exchange plan into a format that can be understood by the power transmission/reception unit, and stores it in the power transmission/reception unit database 104.

As described, the planning for the power transmission/reception unit E has been completed. The predicted remaining time of the adjacent power transmission/reception units has been changed due to the power exchange plan for the power transmission/reception unit E. The process goes back to the beginning of the step 1, the predicted remaining time in the list of the power transmission/reception units excluding the power transmission/reception unit E is recalculated and sorted, a power transmission/reception unit E of a next turn is selected, and planning is executed. The step 1 completes when plans have been devised for all the power transmission/reception units in the power receiving mode.

Step 2: Maximizing Stored Power

Power exchange plans are devised for the power transmission/reception units still in the power transmitting mode when the step 1 has completed. Since power demand should have been met as much as possible in the step 1, the challenge is to maximize the efficiency of power storage.

The exchange plan calculation unit 105 calculates the predicted remaining time until surplus power fills the power storage unit to the full capacity in the power transmission/reception units in the power transmitting mode from a table Yᵣₑₘₐᵢₙ [power transmission/reception unit] for this purpose as the predicted remaining time of the power transmission/reception units in the power receiving mode was calculated from the table Tᵣₑₘₐᵢₙ [power transmission/reception unit] table in the step 1. As the table Yᵣₑₘₐᵢₙ [power transmission/reception unit], what the power transmission/reception units registered in the power transmission/reception unit database 104 can be used.

First, the exchange plan calculation unit 105 sorts the power transmission/reception units in the power transmitting mode by the predicted remaining time until the full power storage capacity is reached, and selects a power transmission/reception unit F having the shortest predicted remaining time. This is because the capacity of this power transmission/reception unit will be full in the nearest future and the surplus power thereof will be discarded if it cannot be stored by power transmission.

Next, the exchange plan calculation unit 105 selects a power transmission/reception unit having the highest power transmission path efficiency at this time from power transmission/reception units adjacent to the power transmission/reception unit F, and devise a power exchange plan to an extent that the capacity of the power transmission path allows. The capacity of the power transmission paths used in the step 1 is excluded from the calculation in advance. Further, power transmission/reception units for which plans have been devised in the step 2 are excluded from the group of the adjacent power transmission/reception units.

When there is a plurality of adjacent power transmission/reception units having comparable efficiency, the exchange plan calculation unit 105 devises a plan to transmit power to power transmission/reception units having longer predicted remaining times until reaching the full power storage capacity. When the surplus power of the power transmission/reception unit F cannot be absorbed by one power transmission/reception unit, the exchange plan calculation unit 105 selects power transmission/reception units to be a second power transmission destination and beyond. In this case, the exchange plan calculation unit 105 first selects ones having higher power transmission path efficiency as well, and then selects ones having longer predicted remaining time until reaching the full power storage capacity.

The power exchange planning for the power transmission/reception unit F has completed as described above. The control instruction generating unit 106 converts the plan into a format that can be understood by the power transmission/reception units and the plan is stored in the power transmission/reception unit database 104. The converted power exchange plan is given to each power transmission/reception unit as the response to the unit state update request described above.

Since the surplus power of the adjacent power transmission/reception units increases due to the power exchange plan for the power transmission/reception unit F, the process goes back to the beginning of the step 2, the predicted remaining times of these power transmission/reception units are recalculated, a power transmission/reception unit F of a next turn is selected, and a plan is devised.

The exchange plan calculation unit 105 repeats the step 2 for all the power transmission/reception units.

A processing cycle of the power exchange planning service has completed as described above. Once the monitoring service updates the virtual electrical grid, another cycle of the power exchange planning is executed.

### 2. The Power Transmission Operation Between the Power Transmission/Reception Units

Next, the power transmission operation between the power transmission/reception units will be described. As described above, the power transmission operation is performed based on the power exchange plan.

First, the power transmission/reception units 300 to 320 access a rendezvous port at a time specified by a power exchange plan, and wait until the partner power transmission/reception unit connects to the same rendezvous port. If the partner has already connected to the rendezvous port, the power transmission/reception units 300 to 320 will immediately proceed to the next step.

When both power transmission/reception units recognize each other, the power transmission/reception unit on the transmitting end transmits power specified in the power exchange plan to a specified path for a specified period of time. When an abnormality is detected in the power transmission path at this time, the power transmission/reception unit on the transmitting end immediately stops the transmission, notifies the power transmission/reception unit on the receiving end of the abnormality and the reason via the rendezvous port, and closes the rendezvous port. Since the virtual electrical grid building apparatus 100 logs the abnormality notification and the fact that the rendezvous port has been closed, the administrator is able to confirm what has happened afterwards. The power transmission/reception unit on the receiving end immediately detects an abnormality from the notification and a failure to access the rendezvous port and is able to stop receiving power.

The power transmission/reception unit on the receiving end is able to detect an interruption of power transmission by detecting an abnormality in the power transmission path such as a voltage drop. When detecting an interruption of power transmission, the power transmission/reception unit on the receiving end notifies the partner power transmission/reception unit of the detection result via the rendezvous port, and close the rendezvous port. This situation can occur in a case where the detection of an abnormality notification from the transmitting end is delayed.

As described, the power transmission/reception units on the transmitting and receiving ends monitor the power transmission path during the power transmission. In addition, both power transmission/reception units inquire the virtual electrical grid building apparatus 100 about the power exchange plan at the same interval as the interval (for instance one minute) at which the monitoring service monitors the virtual electrical grid. This is because the power exchange plan may change during the execution of a power exchange. When the power exchange plan is changed, the power transmission/reception units stop the current power transmission and immediately proceed with the execution of the next power transmission plan.

Further, when the capacity of the power storage unit 306 of the power transmission/reception unit on the receiving end becomes full during the power transmission, this power transmission/reception unit informs the power transmission/reception unit on the transmitting end via the rendezvous port that the capacity is full, and stops receiving power. The remaining amount of power scheduled to be exchanged is included in a next power exchange plan if necessary.

Further, when the power storage unit 306 of the power transmission/reception unit on the transmitting end becomes empty during the power transmission, this power transmission/reception unit similarly notifies the power transmission/reception unit on the receiving end of the fact that the capacity is zero via the rendezvous port and stops the power transmission. The remaining amount of power that was supposed to be exchanged will be included in a next power exchange plan if necessary.

Finally, regardless of the outcome of the power transmission (success or cancellation), both power transmission/reception units report the final state of the power transmission/reception unit (the remaining capacity of the power storage unit 306, the amount supplied to consumers, the efficiency of the power transmission path, etc.) to the virtual electrical grid building apparatus 100. This power exchange plan has completed at this point.

### 3. The Overall Operation of the System

A sequence of operations for arranging the power transmission/reception units in a demand area and building a demand area power system in a situation in which the virtual electrical grid building apparatus 100 operates in the network will be described. It is assumed that the communication network 200 between the power transmission/reception units 300 to 320 and the virtual electrical grid building apparatus 100 is available and that the power transmission/reception units 300 to 320 hold the network address (such as a URL of each demand area power system) of the virtual electrical grid building apparatus 100, and the explanation of how to configure this portion will be omitted.

First, upon starting up, the power transmission/reception units 300 to 320 confirm the power storage units thereof and the unit IDs. Further, the power transmission/reception units 300 to 320 recognize adjacent power transmission/reception units directly connected to the power transmitting unit 305 and the power receiving unit 304.

For the recognition of adjacent power transmission/reception units, for instance, unit ID exchanges between directly connected power transmission/reception units using power line communication (PLC) can be utilized. In a case of one-way power transmission such as microwave power transmission or laser power transmission, by irradiating the unit IDs using these electromagnetic waves, adjacent power transmission/reception units capable of transmitting power to a particular power transmission/reception unit can be recognized. Similarly, the power transmission/reception units 300 to 320 may notify the unit IDs thereof by transmitting the unit IDs to all the paths through which power can be transmitted.

Further, the power transmission/reception units obtain or measure the properties of the power storage units and the power transmission paths. Out of these, the maximum input and the maximum output of the storage battery can be recorded in the power transmission/reception units in advance. Further, it is preferred that the discharge characteristics and power transmission efficiency should be measured by actually transmitting power. The characteristics may deteriorate after repeated charging and discharging, and the efficiency may be zero due to a failure in the path when power is transmitted. In this case, the power storage unit 306, the power transmitting unit 305, and the power receiving unit 304 become unavailable (perhaps temporarily). In addition, other path characteristics include the power transmission efficiency changing greatly depending on the situation such as rain, the path being available only at certain times of the day, and being able to transmit power only by a small amount.

After collecting the specification and property information, the power transmission/reception units 300 to 320 transmit a “unit registration request” to the virtual electrical grid building apparatus 100 (refer to S101 in FIG. 7). The collected specifications and properties are included in the data that accompanies the request.

The virtual electrical grid building apparatus 100 processes the unit registration request with the unit registration service. When the request source power transmission/reception unit is determined to be an acceptable and legitimate power transmission/reception unit as a result, a response saying, “Registration successful,” is sent to the power transmission/reception unit, which will then be included in the virtual electrical grid.

The registered power transmission/reception unit collects the latest state thereof thereafter, and suitably transmits the information to the virtual electrical grid building apparatus 100 (refer to S201 in FIG. 7). In particular, the latest state of the power transmission/reception unit must be reliably transmitted to the virtual electrical grid building apparatus 100 before the period (for instance within 10 minutes) in which the virtual electrical grid building apparatus 100 determines that the power transmission/reception unit has failed.

In a case where a power transmission/reception unit is not able to transmit the latest state thereof to the virtual electrical grid building apparatus 100 for a long period of time for some reason and the virtual electrical grid building apparatus 100 disconnects this power transmission/reception unit from the virtual electrical grid after determining that the power transmission/reception unit has failed as a result, the power transmission/reception unit must start the processing from the unit registration request again in order to be included in the virtual electrical grid since the virtual electrical grid building apparatus 100 will not accept any request from this power transmission/reception unit thereafter.

The virtual electrical grid building apparatus 100 checks the states of all the registered power transmission/reception units at a predetermined interval (for instance every minute). When the state of a power transmission/reception unit has not been updated for a certain period of time (for instance 10 minutes), this power transmission/reception unit is removed from the electrical grid. Next, the power exchange calculation unit [exchange plan calculation unit?] 105 devises a power exchange plan for each unit in the virtual electrical grid (refer to S203 in FIG. 7) and stores the plan in the power transmission/reception unit database 104.

In order to confirm whether or not a power exchange plan has been created, the power transmission/reception units 300 to 320 inquire the virtual electrical grid building apparatus 100 at a predetermined interval (the same interval as the interval period of the monitoring service or multiples thereof). If there is a power exchange plan, the power transmission/reception unit follows the instruction thereof, accesses a rendezvous port at a specified time, and exchanges power after meeting up with the partner power transmission/reception unit.

Since the power exchange plan may be changed while power is exchanged, the power transmission/reception units 300 to 320 inquire the virtual electrical grid building apparatus 100 at the same interval and follow a new plan if the plan is changed.

When power is supplied from the input unit 307 while the system is running as described, the power transmission/reception units 300 to 320 accumulate power in the power storage unit 306. When the capacity of the power storage unit 306 becomes full, the power transmission/reception units 300 to 320 close the rendezvous port of the virtual electrical grid building apparatus 100 if there is any power exchange plan being executed since the input is shut off and power supply from the power receiving unit 304 is stopped. Triggered by the closing of the rendezvous port, the partner power transmission/reception unit stops subsequent power transmission, ending the power exchange.

Further, when power is consumed from the output unit 308 while the system is running as described, the power transmission/reception units 300 to 320 supplies power from the power storage unit 306. When the capacity of the power storage unit 306 becomes empty, the power transmission/reception units close the rendezvous port of the virtual electrical grid building apparatus 100 if there is any power exchange plan being executed since the power supply is stopped and power transmission from the power transmitting unit 305 is stopped. Triggered by the closing of the rendezvous port, the partner power transmission/reception unit stops subsequent power reception, ending the power exchange.

As described, the present exemplary embodiment provides a remarkable effect that an ad hoc demand area power system can be quickly and simply built. The reason for this is that the virtual electrical grid building apparatus is able to autonomously calculate electric power supply and demand matching and transmission paths, and dynamically configure an electrical grid by working together with the power transmission/reception units. All an operator needs to do is connect the power transmission/reception units.

Further, according to the present exemplary embodiment, an optimal demand area power system can be automatically configured in an environment where various power transmission qualities are mixed. The reason for this is that the power transmission/reception unit measures the characteristics of the power transmission path and the virtual electrical grid building apparatus devises a power exchange plan while taking into account these characteristics.

Further, according to the present exemplary embodiment, an electrical grid can automatically reconfigured in the event of a failure in a power transmission path. The reason for this is that the power transmission/reception unit measures the characteristics of the power transmission path and the virtual electrical grid building apparatus devises a power exchange plan while taking into account these characteristics.

Further, according to the present exemplary embodiment, a consumer is able to receive stable power less susceptible to power variation on the supplier's end. The reason for this is that power is first stored in the battery of the power transmission/reception unit before being supplied. The storage battery acts as a buffer and the consumer is unaffected by power variation on the supplier's end and variation in exchanged power.

Further, according to the present exemplary embodiment, the maintenance of a demand area power system is facilitated. The reason for this is that, when the power transmission/reception unit is disconnected from the demand area power system due to a failure, shutoff, or displacement, the virtual electrical grid building apparatus and the power transmission/reception unit exchanging power with the first power transmission/reception unit automatically recognize the event and autonomously reconfigure the electrical grid. No operation by an operator is required.

Further, according to the present exemplary embodiment, the expansion of a demand area power system is also facilitated. The reason for this is that, since an added power transmission/reception unit automatically registers itself to the virtual electrical grid building service, the virtual electrical grid building service can immediately update a power exchange plan and autonomously reconfigure the electrical grid. No operation by an operator is required.

Further, according to the present exemplary embodiment, a consumer and supplier (such as an EV) on the move are able to configure a demand area power system. The reason for this is that the virtual electrical grid building service treats the path characteristics as something that changes over time. The power transmission/reception unit measures the path characteristics and reports them to the virtual electrical grid building service, taking into account original physical properties (decreased efficiency while being moved). The virtual electrical grid building service calculates the actual power transmission efficiency from changes in the power storage amount.

An exemplary embodiment of the present invention has been described above, however, the present invention is not limited to the exemplary embodiment described and further modifications, substitutions, and adjustments can be added within the scope of the basic technological concept of the present invention. For instance, the network configuration, the configuration of the elements, and the message expression shown in each drawing is merely an example to facilitate the understanding of the present invention, which is not limited to these configurations shown in the drawings.

For instance, the digital grid described in Non-Patent Literatures 3 to 5 can be used along with the present invention. It is possible to have a demand area power system configured by the present invention exchange power with a second demand area power system by connecting it to a digital grid router (DGR). At this time, the DGR should be connected to the input unit 307 and the output unit 308 of the power transmission/reception unit. The power supplied through the DGR from the second demand area power system is treated in the same manner as the power generation input in the power transmission/reception unit connected to DGR, and the power sent to the second demand area power system can be treated in the same manner as the power consumption in the power transmission/reception unit connected to the DGR.

Further, the present invention can be operated together with a power exchange trading system. In this case, the virtual electrical grid building apparatus 100 receives a power trading plan from a trading system and is able to devise a more optimal power exchange plan, taking into account revenue from electric power sales and external power procurement.

Further, the virtual electrical grid building apparatus 100 was described as a single device in the exemplary embodiment above, however, it can be realized by a plurality of physical servers since it is a service over a network. Further, the virtual electrical grid building apparatus 100 may be constituted by a public service (public cloud, energy cloud, etc.) on the Internet or it may be constituted by a service over a private network.

Further, various revisions and modifications are possible for the power transmission/reception units 300 to 320. For instance, IDs of consumers and suppliers can be used as the ID of the power transmission/reception unit, instead of having the ID generating unit 302. In a case where consumers and suppliers are fixed facilities such as a building(s), this method facilitates the replacement of the power transmission/reception unit in the event of a failure.

Further, it is not necessary to configure all the power transmission/reception units identically. For instance, some power transmission/reception units may lack the power storage unit 306 and transmit all the power received by the power receiving unit 304 with the power transmitting unit 305. Such a power transmission/reception unit functions as an intermediate hub connecting two power transmission paths.

A demand area power system interconnected to a grid can built by connecting the power transmission/reception unit to a power feeding system. In this case, power exchanges between the power transmission/reception units correspond to the purchase and sale of electricity from the point of view of the power feeding system. In Japan, the unit price of electricity sales changes depending on the purchase time of facilities, and that of electricity purchases depending on the total amount of power. In electricity sales, the unit price for facilities installed in 2009 is 49 yen per 1 kWh for 10 years, 42 yen for facilities installed in 2011, and 38 yen for facilities installed in 2013. In electricity purchases, 2013 Meter-Rate Lighting B shows prices of 18.89 yen per 1 kWh in the first stage up to 120 kWh, 25.19 yen in the second stage up to 300 kWh, and 29.10 yen in the third stage of 300 kWh or more. There are plans in which daytime and nighttime have different electricity purchase prices.

With the existence of a county and corporations employing such an asymmetric and nonlinear price structure, power exchanges between the power transmission/reception units, which are supposed to be equal, are not symmetrical in terms of price. Power exchange planning needs to take the such asymmetry and nonlinearity into consideration. More concretely, power exchange calculations can include additional restrictions such as that power exchanges are performed with the purchase price on the power receiving end as low as possible, many power transmission/reception units are able to receive divided small amounts of surplus power, a power transmission/reception unit with free storage power capacity is not allowed to store power if the consumer thereof is not expected to consume it, and power transmission to a power transmission/reception unit having a large amount of power consumption is kept to a minimum.

It goes without saying that a configuration with the enhanced independence of the demand area power system in which a dedicated path is provided for the connection between the power transmission/reception units can be also employed. For instance, an independent electrical grid can be buried in a parking lot and connected to an electric vehicle (EV) via wireless power transmission. According to this configuration, the parking lot becomes a demand area power system independent of a power feeding system by using the electric vehicle as the power transmission/reception unit.

Finally, preferred modes of the present invention will be summarized.

### [Mode 1]

(Refer to the demand area power system building system according to the first aspect.)

### [Mode 2]

In the demand area power system building system of Mode 1,

an address is set for each demand area power system in the virtual electrical grid building apparatus,

the power transmission/reception unit announces participation to a particular demand area power system by transmitting a participation request to the address, and

the virtual electrical grid building apparatus builds a demand area power system on the basis of the participation request for each address.

### [Mode 3]

In the demand area power system building system of Mode 1 or 2, the virtual electrical grid building apparatus comprises:

a power transmission/reception unit information storage unit that manages capability information of each power transmission/reception unit;

a power transmission/reception unit managing unit that manages the capability information and the topology of the power transmission/reception units; and

an exchange plan calculation unit that calculates a power exchange plan including power exchanges between the power transmission/reception units on the basis of the capability information and the topology of the power transmission/reception units.

### [Mode 4]

In the demand area power system building system of Mode 3, the virtual electrical grid building apparatus calculates a power exchange plan so as to satisfy the needs of a consumer and to maximize the power storage amount of each power transmission/reception unit on the basis of the capability information of each power transmission/reception unit.

### [Mode 5]

In the demand area power system building system of Mode 3 or 4, the power transmission/reception unit reports the state thereof to the virtual electrical grid building apparatus via the communication network at a predetermined time interval, and

the virtual electrical grid building apparatus recalculates the power exchange plan on the basis of the report.

### [Mode 6]

In the demand area power system building system of Mode 5, the virtual electrical grid building apparatus excludes any power transmission/reception unit that has not reported the state thereof for a predetermined period of time from demand area power system building subjects.

### [Mode 7]

In the demand area power system building system of any one of Modes 1 to 6,

the virtual electrical grid building apparatus further comprises a rendezvous port managing unit that relays communication between the power transmission/reception units unable to directly communicate with each other out of the power transmission/reception units.

### [Mode 8]

In the demand area power system building system of any one of Modes 1 to 7,

the virtual electrical grid building apparatus further comprises a control instruction generating unit that generates a control instruction for the power transmission/reception unit on the basis of the power exchange plan, stores the control instruction for the power transmission/reception unit in the power transmission/reception unit information storage unit, and transmits the control instruction stored in the power transmission/reception unit information storage unit to a power transmission/reception unit that has reported the state thereof.

### [Mode 9]

(Refer to the virtual electrical grid building apparatus according to the second aspect.)

### [Mode 10]

(Refer to the power transmission/reception unit according to the third aspect.)

### [Mode 11]

(Refer to the demand area power system building method according to the fourth aspect.)

### [Mode 12]

A program having a computer constituting a virtual electrical grid building apparatus connected via a communication network to at least one power transmission/reception unit that comprises a power storage unit and power transmitting and receiving units capable of transmitting and receiving power to/from another power transmission/reception unit via an electrical grid and that is configured to be able to provide power accumulated in the power storage unit to the outside or to be able to accumulate power supplied from the outside execute:

receiving an announcement of participation to a demand area power system from the power transmission/reception unit via the communication network; and

building a demand area power system using the power transmission/reception unit that has announced participation to the demand area power system.

Further, as Mode 1, Modes 9 to 12 can be developed into Modes 2 to 8.

Further, the disclosure of each Patent Literature and Non-Patent Literature listed above is incorporated herein in its entirety by reference thereto. It should be noted that other objects, features and aspects of the present invention will become apparent in the entire disclosure and that modifications may be done without departing the gist and scope of the present invention as disclosed herein and claimed as appended herewith. Also it should be noted that any combination of the disclosed and/or claimed elements, matters and/or items may fall under the modifications aforementioned. Particularly, the ranges of the numerical values used in the present description should be interpreted as a specific numeric value or small range included in the ranges even when no specific explanation is provided.

What is claimed is:

1. A demand area power system building system including:
at least one power transmission/reception unit that comprises a power storage unit and power transmitting and receiving units capable of transmitting and receiving power to/from another power transmission/reception unit via an electrical grid and that is configured to be able to provide power accumulated in the power storage unit to the outside or to be able to accumulate power supplied from the outside;
a virtual electrical grid building apparatus, connected to the power transmission/reception unit via a communication network, that controls the power transmission/reception unit so as to provide power to a demand area;
the power transmission/reception unit being adapted to announce participation to a demand area power system via the communication network; and
the virtual electrical grid building apparatus building a demand area power system using the power transmission/reception unit that has announced participation to the demand area power system.

2. The demand area power system building system according to claim 1, wherein an address is set for each demand area power system in the virtual electrical grid building apparatus,
the power transmission/reception unit announces participation to a particular demand area power system by transmitting a participation request to the address, and
the virtual electrical grid building apparatus builds a demand area power system on the basis of the participation request for each address.

3. The demand area power system building system according to claim 1, wherein
the virtual electrical grid building apparatus comprises a power transmission/reception unit information storage unit that manages capability information of each power transmission/reception unit, a power transmission/reception unit managing unit that manages the capability information and the topology of the power transmission/reception units, and an exchange plan calculation unit that calculates a power exchange plan including power exchanges between the power transmission/reception units on the basis of the capability information and the topology of the power transmission/reception units.

4. The demand area power system building system according to claim 3, wherein the virtual electrical grid building apparatus calculates a power exchange plan so as to satisfy the needs of a consumer and to maximize the power storage amount of each power transmission/reception unit on the basis of the capability information of each power transmission/reception unit.

5. The demand area power system building system according to claim 3, wherein the power transmission/reception unit reports the state thereof to the virtual electrical grid building apparatus via the communication network at a predetermined time interval, and the virtual electrical grid building apparatus recalculates the power exchange plan on the basis of the report.

6. The demand area power system building system according to claim 1, wherein the virtual electrical grid building apparatus further comprises a rendezvous port managing unit that relays communication between the power transmission/reception units unable to directly communicate with each other out of the power transmission/reception units.

7. The demand area power system building system according to claim 1, wherein the virtual electrical grid building apparatus further comprises a control instruction generating unit that generates a control instruction for the power transmission/reception unit on the basis of the power exchange plan, stores the control instruction for the power transmission/reception unit in the power transmission/reception unit information storage unit, and transmits the control instruction stored in the power transmission/reception unit information storage unit to a power transmission/reception unit that has reported the state thereof.

8. A virtual electrical grid building apparatus connected via a communication network to at least one power transmission/reception unit that comprises a power storage unit and power transmitting and receiving units capable of transmitting and receiving power to/from another power transmission/reception unit via an electrical grid and that is configured to be able to provide power accumulated in the power storage unit to the outside or to be able to accumulate power supplied from the outside, wherein
the power transmission/reception unit is adapted to announce participation to a demand area power system via the communication network, and
the virtual electrical grid building apparatus controls the power transmission/reception unit so as to provide power to a demand area by building a demand area power system using the power transmission/reception unit that has announced participation to the demand area power system.

9. At least one power transmission/reception unit comprising a power storage unit and power transmitting and receiving units capable of transmitting and receiving power to/from another power transmission/reception unit via an electrical grid and that is configured to be able to provide power accumulated in the power storage unit to the outside or to be able to accumulate power supplied from the outside, the power transmission/reception unit being capable of announcing participation to a demand area power system via a communication network to a virtual electrical grid building apparatus that calculates a network configuration of the power transmission/reception units; and having the virtual electrical grid building apparatus build a demand area power system.

10. A demand area power system building method in a demand area power system building system including at least one power transmission/reception unit that comprises a power storage unit and power transmitting and receiving units capable of transmitting and receiving power to/from another power transmission/reception unit via an electrical grid and that is configured to be able to provide power accumulated in the power storage unit to the outside or to be able to accumulate power supplied from the outside and a virtual electrical grid building apparatus connected to the power transmission/reception unit via a communication network, the demand area power system building method including:
receiving an announcement of participation to a demand area power system from the power transmission/reception unit via the communication network; and
building a demand area power system using the power transmission/reception unit that has announced participation to the demand area power system.

11. The demand area power system building system according to claim 2, wherein
the virtual electrical grid building apparatus comprises a power transmission/reception unit information storage unit that manages capability information of each power transmission/reception unit, a power transmission/reception unit managing unit that manages the capability information and the topology of the power transmission/reception units, and an exchange plan calculation unit that calculates a power exchange plan including power exchanges between the power transmission/reception units on the basis of the capability information and the topology of the power transmission/reception units.

12. The demand area power system building system according to claim 4, wherein the power transmission/reception unit reports the state thereof to the virtual electrical grid building apparatus via the communication network at a predetermined time interval, and the virtual electrical grid building apparatus recalculates the power exchange plan on the basis of the report.

13. The demand area power system building system according to claim 2, wherein the virtual electrical grid building apparatus further comprises a rendezvous port managing unit that relays communication between the power transmission/reception units unable to directly communicate with each other out of the power transmission/reception units.

14. The demand area power system building system according to claim 3, wherein the virtual electrical grid building apparatus further comprises a rendezvous port managing unit that relays communication between the power transmission/reception units unable to directly communicate with each other out of the power transmission/reception units.

15. The demand area power system building system according to claim 4, wherein the virtual electrical grid building apparatus further comprises a rendezvous port managing unit that relays communication between the power transmission/reception units unable to directly communicate with each other out of the power transmission/reception units.

16. The demand area power system building system according to claim 5, wherein the virtual electrical grid building apparatus further comprises a rendezvous port managing unit that relays communication between the power transmission/reception units unable to directly communicate with each other out of the power transmission/reception units.

17. The demand area power system building system according to claim 2, wherein the virtual electrical grid building apparatus further comprises a control instruction generating unit that generates a control instruction for the power transmission/reception unit on the basis of the power exchange plan, stores the control instruction for the power transmission/reception unit in the power transmission/reception unit information storage unit, and transmits the control instruction stored in the power transmission/reception unit information storage unit to a power transmission/reception unit that has reported the state thereof.

18. The demand area power system building system according to claim 3, wherein the virtual electrical grid building apparatus further comprises a control instruction generating unit that generates a control instruction for the power transmission/reception unit on the basis of the power exchange plan, stores the control instruction for the power transmission/reception unit in the power transmission/reception unit information storage unit, and transmits the control instruction stored in the power transmission/reception unit information storage unit to a power transmission/reception unit that has reported the state thereof.

19. The demand area power system building system according to claim 4, wherein the virtual electrical grid building apparatus further comprises a control instruction generating unit that generates a control instruction for the power transmission/reception unit on the basis of the power exchange plan, stores the control instruction for the power transmission/reception unit in the power transmission/reception unit information storage unit, and transmits the control instruction stored in the power transmission/reception unit information storage unit to a power transmission/reception unit that has reported the state thereof.

20. The demand area power system building system according to claim 5, wherein the virtual electrical grid building apparatus further comprises a control instruction generating unit that generates a control instruction for the power transmission/reception unit on the basis of the power exchange plan, stores the control instruction for the power transmission/reception unit in the power transmission/reception unit information storage unit, and transmits the control instruction stored in the power transmission/reception unit information storage unit to a power transmission/reception unit that has reported the state thereof.
